(19) United States
(12) Patent Application Publication
(10) Pub. No.: US 2011/0021052 A1
(43) Pub. Date: Jan. 27, 2011

(54) STACKED FPC CONNECTOR

(75) Inventors: Hideyuki Hirata, Kanagawa (JP); Hideo Nagasawa, Kanagawa (JP); Cong Li, Liaoning Province (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/440,798

(22) PCT Filed: Sep. 11, 2007
(86) PCT No.: PCT/US07/19694

§ 371 Date: Jul. 20, 2010

(30) Foreign Application Priority Data
Sep. 11, 2006 (JP) 2006-245844

(51) Int. Cl. H01R 13/62

(52) U.S. Cl. 439/325

(57) ABSTRACT

A connector for joining together two lengths of FPC or FFC-type cable has a housing (31) and two FPC-cable-receiving slots (33) formed therein, on the same side of the housing. The slots are disposed in the housing on opposite sides of an axis of symmetry, and the slots each contain a plurality of conductive terminals (41). The terminals each have a fixed contact beam (43) spaced apart and aligned with a moveable contact beam (44). The contact beams flank each of the cable-receiving slots and are pressed into contact with contact portions of the FPC cable by actuators (11) that are moved in opposite directions. The actuators spread the contact beams apart in response to movement in one direction and urge them toward each other in the other direction.

### BACKGROUND OF THE INVENTION

The present invention relates generally to FPC connectors, and more particularly to a FPC connector that interconnects two lengths of the cable in a stacked fashion.

Connectors for connecting two flat sheet-like cables such as flexible printed circuits (FPC), flexible flat cables (FFC) are known as shown by Japanese Patent Laid-Open (Kokai) No. H 10-189185.

FIG. 8 is a perspective view illustrating such a conventional FPC connector. This connector includes a housing 301 made of an insulating material a plurality of conductive terminals 302 held in the housing 301. The terminals 302 are press-fit into terminal mounting holes formed in opposite sides (front-left side and right-back side in the drawing) of the housing 301. The terminals 302 have cantilever-like contact portions (not shown) extending from the external side of the housing 301 towards the center thereof, and onto the top sides of the contact portions of FPC cables inserted into the connector.

Locking levers 303 and 304 are rotatably attached to the housing 301, and rotate about 90 degrees around a revolving shaft. In FIG. 8, the locking levers 303 and 304 are shown in locked positions parallel to a top plate 305 of the housing 301.

When the FPC cables are connected, the locking levers 303 and 304 are rotated upwardly and then the ends of the FPC cables are inserted into slits on both sides of the housing 301. Once the FPC ends are inserted, locking levers 303 and 304 are rotated to lock in place as shown and parallel to the top plate 305. This forces the conductive lines of the FPC cables to contact the contact portions of the terminals 302. The two FPC cables are thereby connected via the terminals 302 to conductive traces on a circuit board (not shown) to which the terminals 302 are soldered.

However, since the conventional connector is formed so that the terminals 302 may be attached to the housing 301 having an almost symmetric shape from both sides thereof, and the flat sheet-like cables may be inserted from right and left sides of the housing 301, the housing 301 is complex in shape, and grows in size. This causes the structure of a metallic mold for forming the housing 301 to become complex and expensive and the mass productivity to decline. In order to connect the two FPC cable ends to each other, it is necessary to connect the terminals 302 to each other from both sides via the conductive trace of the circuit board, this causes workability to decline.

### SUMMARY OF THE INVENTION

It is an object of the present invention, by solving the problems of the conventional connector, to provide a connector with a housing having a pair of cable insertion openings arranged in the same direction, a pair of actuators, and terminals fitted in common into the cable insertion openings which enable the actuators to actuate independently, the connector enabling a simple to manufacture structure of each member thereof and easy to assemble members resulting in high mass productivity.

Therefore, a connector according to the present invention is a relay connector containing a housing provided with a pair of cable insertion openings or slots, into which ends of pair of circuit substrates such as, FPC are inserted, terminals are fitted into the cable insertion openings, and a pair of actuators capable of movement between a first position in which insertion of the FPC cable ends is possible, and a second position in which the contacts of the FPC cables and the terminals are connected together, wherein the pair of cable insertion openings open in the same direction, the terminals are common to the pair of cable insertion openings, and the actuators are movable independently from each other.

In another aspect of the connectors of the present invention, each terminal includes first and second contact beams being disposed on opposite sides of the FPC, within cable insertion openings wherein the first and second contact beams include projections into the cable insertion openings which oppose each other.

In yet another aspect of the connectors of the present invention, each terminal further has a symmetrical shape centered about a straight line interposed between the pair of cable insertion openings.

In still a further aspect of the present invention, each of the terminals further includes two pairs of first and second contact beams that are joined together by a mounting portion that extending along an axis of symmetry and which fixes the terminal to the housing, and wherein all portions of the terminals are located inside of the housing.

According to the present invention, a FPC connector contains a housing including a pair of cable insertion openings which open in the same direction, a pair of actuators, terminals disposed in the pair of cable insertion openings, and independently operating actuators. This enables the structure of the connector to be simple and manufactured and assembled together easily, resulting in reduced cost and efficient high mass production.

### BRIEF DESCRIPTION OF THE DRAWINGS

FIG. 1 is a perspective view (partially in section) showing a connector constructed in accordance with the principles of the present invention;

FIG. 2 is a perspective view of the connector of FIG. 1 taken from a different angle;

FIG. 3 is a cross-sectional view of the connector of FIG. 1 and showing that actuators thereof in their open position;

FIG. 4 is the same view as FIG. 3, but with an FPC cable inserted into the top cable-receiving opening;

FIG. 5 is the same view as FIG. 4, but with the actuator closed on the FPC cable;

FIG. 6 is the same view as FIG. 5, but showing an FPC cable inserted into the bottom cable insertion opening;

FIG. 7 is the same view as FIG. 6, but showing the bottom actuator closed on its FPC cable; and,

FIG. 8 is a perspective view of a conventional FPC connector.

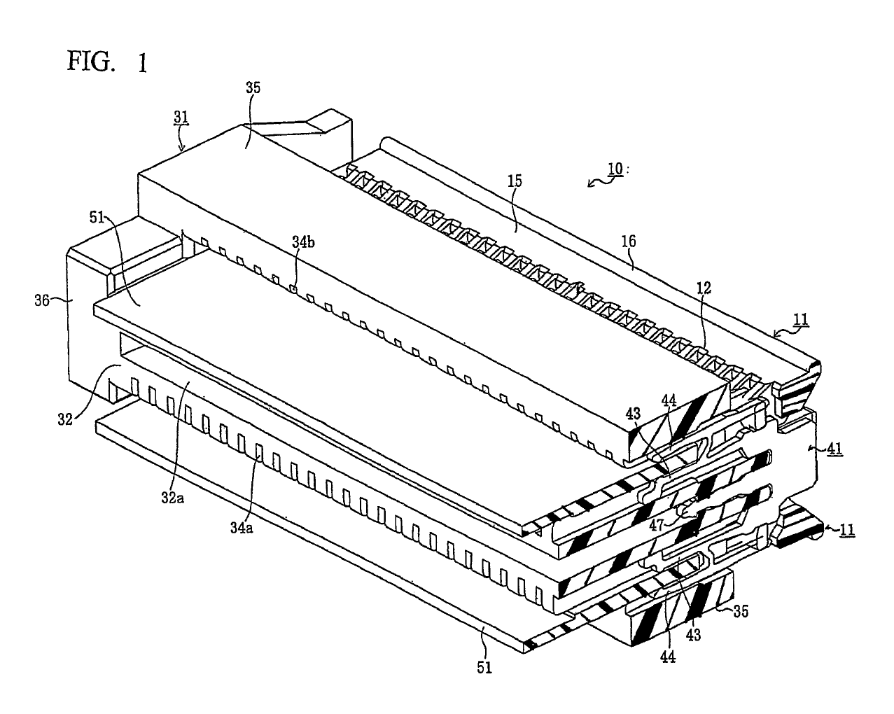

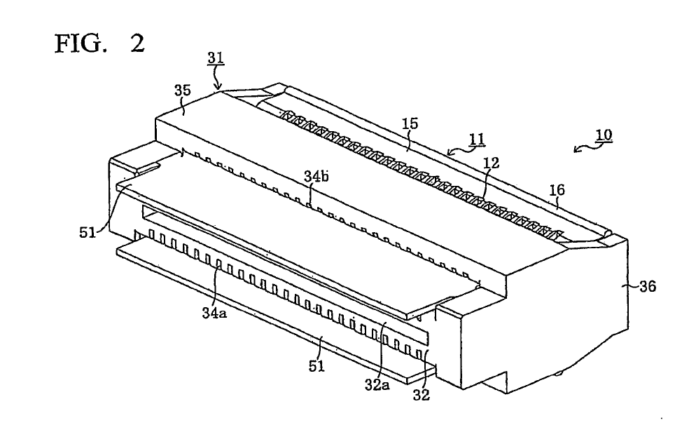

### DESCRIPTION OF THE PREFERRED EMBODIMENT

In the drawings, reference numeral 10 represents a connector serving as a relay connector according to this embodiment, and is used for electrically connecting two circuit substrates such as flat cables 51 to each other. The flat cables 51 are, for example, flexible flat cables referred to as FPC, FFC and so forth, but any types of cables may be acceptable as long as those are flat sheet-like cables provided with conductive lines or traces, including flexible ribbon cables and printed circuit boards. In this embodiment, representations showing directions such as up, down, left, right, front, rear, and the like, to be used for describing the structure and movement of each part of the connector 10 are not absolute, but relative. These representations are appropriate if each part of the connector 10 takes an attitude shown in the drawing figures, however, if the connector 10 changes the attitude thereof, these representations should be understood in amendment according to the change in the attitude of the connector 10.

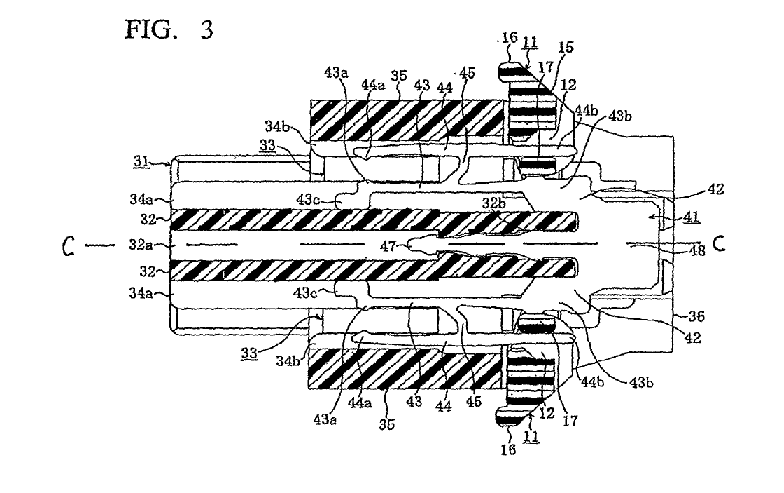

The connector 10 includes a housing 31 provided with a pair of cable insertion openings 33, or slots, opening in the same direction (to the left of FIG. 3), a pair of movable actuators 11, and terminals 41 being fitted in common into the pair of cable insertion openings 33. The housing 31 is formed by molding or the like, an insulating material such as synthetic resin, and functions as a main body of the connector. The housing 31 has a vertically-symmetric structure, and the cross-sectional shape thereof forms a symmetrical shape centering on a center line C-C extending in the lateral direction as the axis of symmetry in FIG. 3.

Each actuator 11 is also formed of an insulating material and functions to fix the free ends of the FPC cables or circuit board to the connector housing. Each actuator 11 is movably attached to the top and bottom of the housing 31. Each actuator 11 is disposed in the housing 31 for movement between an opened position (a first position) and a closed position (a second position). The terminals 41 are formed of a conductive material such as metal, and preferably formed by means of punching out a metallic plate. Each terminal 41 is also vertically symmetrical around the axis of symmetry C-C (FIG. 3) as shown and is fitted into the upper and lower cable insertion openings 33. Each terminal 41 is provided with a symmetric shape centering on the straight imaginary axis line C-C between the pair of cable insertion openings 33. If the connectors in the drawings were rotated 90° clockwise, the connector of terminals would exhibit horizontal symmetry.

In FIG. 3, the housing 31 includes thick plate-like center portions 32 extending in a lateral direction, with thick-plate like top plate portions 35 being disposed on opposite sides of the center portions 32 and extending laterally within the housing. The cable insertion openings 33 are formed between the center portions 32 and the upper and lower top plate portions 35, and receive the ends of the FPC cables 51 from the front side (left side in FIG. 3). The crosswise dimensions of the upper and lower top plate portions 35 in FIG. 3 are set to be shorter than the center portions 32. The center portions 32 and the upper and lower top plate portions 35 are connected together by way of sidewalls 36 disposed on both sides of the housing 31.

In the cable insertion openings 33, a plurality of first terminal-receiving grooves 34a and second terminal accepting grooves 34b are provided into which the terminals 41 are fitted. The first terminal accepting grooves 34a and the second terminal-receiving grooves 34b are formed on the surfaces on the side of the top plate portion 35 of the center portion 32, and on the surface on the side of the center portion 32 of the top plate portion 35, respectively, and those are situated in the position facing to each other. When the first terminal-receiving grooves 34a and the second terminal-receiving grooves 34b are described collectively, those will be described as terminal-receiving grooves 34. For example, about twenty-five of the terminal-receiving grooves 34 are formed with approximately 0.5 mm pitch, and one terminal 41 is fit into each of the terminal accepting grooves 34. The pitch and quantity of the terminal accepting grooves 34 may be changed as appropriate. Further, the terminals 41 are not always necessary to be fitted into all the terminal accepting grooves 34, and it is possible to omit the terminals 41 as necessary in response to the arrangement of contact portions of the FPC cables 51.

In each of the center portions 32, a slit or center opening 32a is formed and it opens in the same direction as the cable insertion openings 33, and at the back portion (right of FIG. 3) of the center opening 32a, there is a terminal fixing hole 32b into which a mounting leg portion 47 serving as a mounting portion of the terminal 41 is fitted. The same quantity and the same pitch of the terminal fixing holes 32b as those of the terminal accepting grooves 34 are formed, and each of the terminal fixing holes 32b and each of the terminal-receiving grooves 34 are situated in the corresponding position.

Each actuator 11 is a thick plate-like member having an approximate 4-sided shape, and includes a main body 15 operated by an operator with his/her fingers and the like, and an operation portion 16 bulging from the main body 15 is formed so as to be easily grasped with operator's fingers. In each of the actuators 11, a plurality of holding holes 12 for receiving actuating levers 44b of movable beams 44 of the terminals 41 are formed at the end of the actuator 11 on an opposite side of the operation portion 16. Shaft portions 17 engage with the actuating levers 44b of the movable beams 44 define one surface of the holding holes 12. The actuators 11 are attached to the housing 31 along the upper and lower rear side edges thereof, and when moved to closed positions, the actuators 11 become almost parallel to the top plate portions 35, and when opened, the actuators 11 are almost perpendicular to the top plate portions 35, and the operation portions 16 project above and below the top plate portions 35.

Each of the terminals 41 is symmetrical, and includes a main body portion 42 are held in the first terminal accepting grooves 34a on both sides of the axis of symmetry, and are joined to each other by a coupling portion 48. From the main body portions 42, fixed contact beams 43 extend to the front of the housing 31 as first contact beams. Further, movable contact beams 44 (second contact beams) are connected to the fixed contact beams 43 via coupling beams 45 and extend almost parallel to the fixed contact beams 43 while facing them. The fixed contact beams 43, the movable contact beams 44, and the coupling beams 45 cooperatively form an approximate H-letter shape, and are fitted into the cable insertion openings 33 from the rear of the connector. In this case, the fixed contact beams 43 are held within the first terminal accepting grooves 34a, and the movable contact beams 44 are held within the second terminal accepting grooves 34b. Then, the flat FPC cable, or circuit board, ends 51 are inserted between the movable and fixed contact beams 43 from the front. As noted above, each terminal 41 is symmetrical and it has two pairs of first and second contact beams, on pair received in the first (or top) cable insertion opening and the other pair received in the second (or bottom) cable insertion opening.

The coupling portions 48, mounting leg portions 47 extend to the front of the housing 31 along an axis of symmetry of the terminals 41. The mounting leg portions 47 are pushed into and fitted in the terminal fixing holes 32b from the rear of the housing 31, thereby fixing the terminals 41 to the housing 31. Projecting portions are formed on the side surfaces of each of the mounting leg portions 47, and these projecting portions bite into the inner walls of the terminal fixing holes 32b, in order to enhance the fixing of the mounting leg portions 47 to the housing 31.

Each of the fixed beams 43 includes a tip projecting portion 43c projecting from the cutting edge of the fixing beam 43 towards the front of the connector, a cable supporting portion 43a, also projecting, and being located in the proximity of the tip of the fixing beam 43 and at the rear of the tip projecting portion 43C, and projecting towards the top plate portion 35, and a bearing portion 43b located at the rear end of the fixing beam 43 and connected to the main body portion 42. The tip projecting portions 43c and approximately linear inner end portions of the main body portions 42 abut the floor surfaces of the first terminal accepting grooves 34a, in order to fix the fixed contact beams 43 in place.

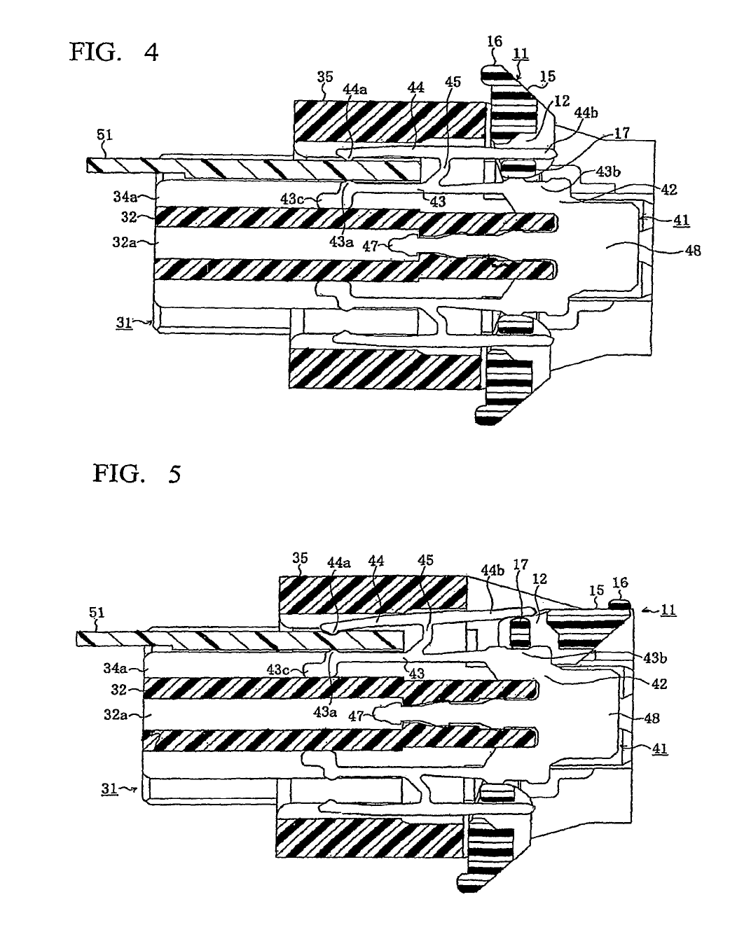

The movable beams 44 function as contacts for the contact portions of the FPC cables 51, and in the proximity of the tips of the movable beams 44, contact portions 44a are formed and they project towards the center portions 32 of the housing into the cable insertion opening. Each of the movable contact beams 44 includes an actuating lever 44b which extends at the rear side connected to the coupling beam 45, and enters the holding hole 12 of the actuator 11 to limit upward movements of the shaft portion 17. The shaft portion 17 is formed to have an elliptical or rectangular shape in cross section, located between the bearing portion 43b and the actuating lever 44b, to function as a cam by rotation, and to push out the actuating lever 44b towards the top plate portion 35. Once the actuating lever 44b is pushed out towards the top plate portion 35, a portion adjacent to the connecting portion between the movable beam 44 and the coupling beam 45 is deformed elastically, and the entire movable contact beam 44 rotates around a portion adjacent to the connecting portion between the movable beam 44 and the coupling beam 45. Thereby, the contact tip of the movable beam 44 is moved towards the center portion 32, and the contact portion 44a is pushed into contact with the FPC cable 51. (FIG. 4)

As shown in FIG. 3, since, when the actuator 11 is in its open position, the shaft portion 17 makes a very small angle that is close to flatness, and each of the actuating levers 44b is not pushed out towards the top plate portion 35, and the tip of the movable contact beam 44 is free and does not move towards the center portion 32. Consequently, there is a sufficient space between the tip of the movable beam 44 and the tip of the fixing beam 43, and the end of the flat FPC cable 51, may be inserted in the cable insertion opening 33 with very little resistance from the contact portion 44a and the cable supporting portion 43a. Therefore, a ZIF (zero insertion force) FPC connector is substantially realized. Each of the terminals 41 does not include any portion projecting outside of the housing 31. In other words, all portions of the terminal 41 are situated inside the external surface of the housing 31.

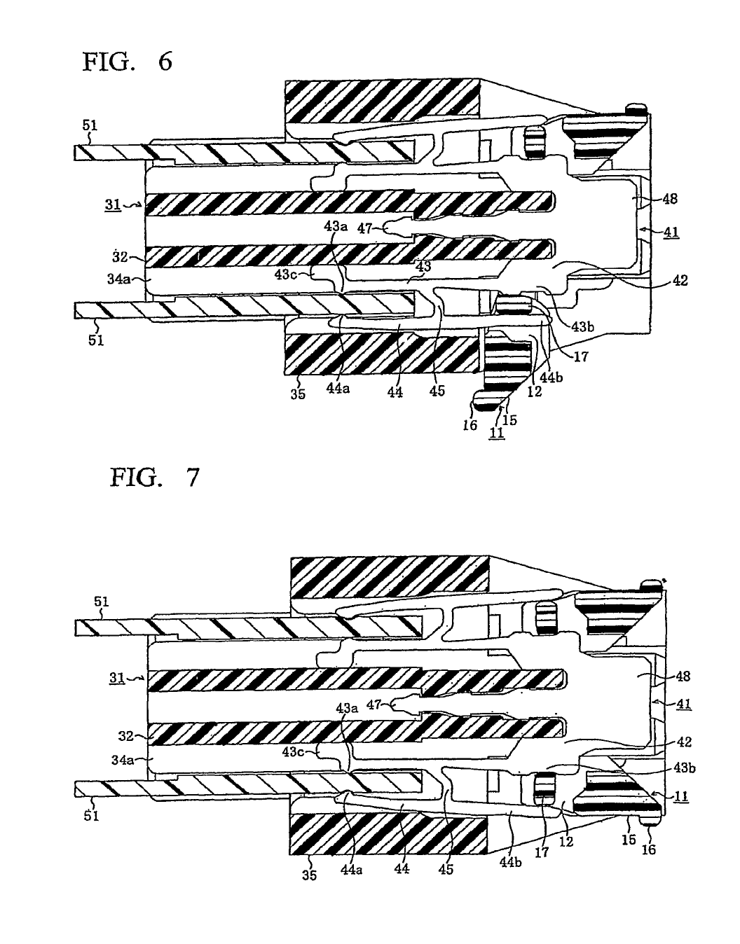

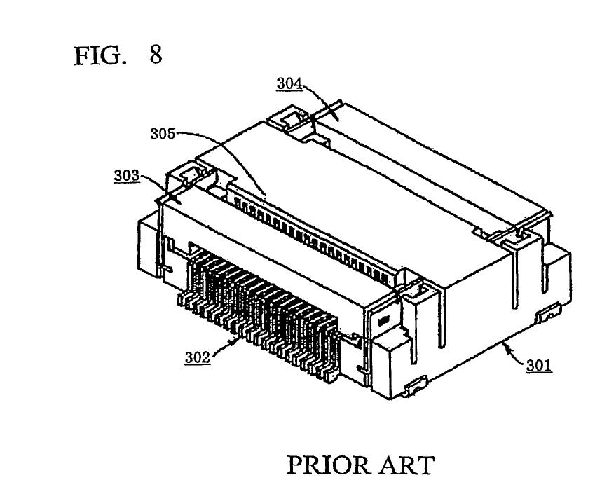

FIG. 4 is a first view showing an operation for connecting a flat sheet-like cable to the connector according to the embodiment of the present invention. FIG. 5 is a second view showing the operation for connecting a flat sheet-like cable to the connector according to the embodiment of the present invention. FIG. 6 is a third view showing the operation for connecting a flat cable to the connector according to the embodiment of the present invention. FIG. 7 is a fourth view showing the operation for connecting a flat cable to the connector according to the embodiment of the present invention.

The FPC cable 51 has a plurality of foil-like conductive lines disposed in parallel on an insulating layer showing electrical insulation properties with predetermined pitch, for example, with about 0.5 mm of pitch. The conductive lines are partially covered with an insulating layer. At the end of the flat FPC cable 51 inserted into the cable insertion opening 33, the top surfaces of the conductive lines are exposed over predetermined length. In FIGS. 4 through 7, it is assumed that the conductive lines are exposed on the surfaces of the flat cables 51 facing the top plate portions 35. Also, accessory plates are attached to the surfaces opposite to the surfaces where the conductive lines at the end portions of the flat cables 51 are exposed. The accessory plates are made of a material with relatively high hardness such as polyimide, and are attached throughout predetermined ranges in the longitudinal direction and the overall ranges in the width direction.

When the flat FPC cable 51 is connected to the connector 10, an end portion of the cable is inserted into the cable insertion opening 33 of the housing 31. As shown in FIG. 3, the actuator 11 is situated in its open position in advance. An operator moves an end of one of the flat cables 51 into upper cable insertion opening 33 of the housing 31, as shown in FIG. 4. The flat FPC cable 51 is moved with the accessory plate facing down and the surface on which the conductive lines are exposed facing up. The tip of the flat FPC cable 51 is inserted between the movable contact beams 44 and the fixed contact beams 43 of the terminals 41 which are fitted in the upper cable insertion opening 33 from the front.

Next, an operator rotates the upper actuator 11 to the closed position as shown in FIG. 5 by rotating it clockwise.

This movement causes the shaft portion 17 to rotate so as to push away the space between the bearing portions 43b and the actuating levers 44b at an angle close to perpendicularity as shown in FIG. 5, and to push the rear actuating levers 44b up toward the top plate portion 35. In other words, it pushes the actuating levers 44b upward, so the tips of the movable beams 44 move down toward the center portion 32, and the contact portions 44a are pressed against the flat FPC cable 51 so that the conductive lines exposed on the surface of the flat FPC cable 51 abuttingly contact the contact portions 44a, and thereby connect the FPC conductive lines and the terminals 41 together. The movable beams 44 are elastic and are elastically deformed by being pushed to the flat sheet-like cable 51, so the connection between the FPC signal lines and the contact portions 44a is well maintained. The cable supporting portions 43a of the fixing beams 43 face the contact portions 44a and the flat cable 51 is reliably supported by the cable supporting portions 43a, so that connection between the signal lines and the contact portions 44a is surely maintained.

An operator then moves an end of the other flat FPC cable 51 into the cable insertion opening 33 on the underside of the housing 31. In this case, the flat FPC cable 51 is moved with the accessory plate facing up and the surface on which the conductive lines are exposed facing down (opposite that of the top FPC cable). Thereafter, the end of the flat FPC cable 51 is inserted between the movable and the fixed contact beams 44,43 of the terminals 41 which are present in the lower cable insertion opening 33.

An operator then operates the lower actuator 11 and moves, the actuator 11 from its open position as shown in FIG. 6 to the closed position as shown in FIG. 7. The bottom actuator 11 is put in its closed position by rotating it counter-clockwise direction.

This causes the shaft portion 17 to rotate to increase the space between the bearing portions 43b and the actuating levers 44b, and thereby push out the actuating levers 44b towards the top plate portion 35 (downward) so that the tips of the movable beams 44 move towards the center portion 32, and the terminal contact portions 44a are pushed against the flat FPC cable 51. The conductive lines exposed on the surface facing the top plate portion 35 of the flat FPC cable 51, (on the lower surface of the flat cable 51) now abut on the contact portions 44a, and the conductive lines and the terminals 41 are thus electrically connected together. The movable beams 44 have elasticity and are deformed by being pressed to the flat sheet-like cable 51, so that connection between signal lines and the contact portions 44a is well maintained. The cable supporting portions 43a of the fixed contact beams 43 are situated in the position facing the contact portions 44a, the flat FPC cable 51 is reliably supported by the cable supporting portions 43a, and connection between the FPC cable and terminals is reliably maintained.

In this way, when the cables 51 are inserted into the cable insertion openings 33 of the connector 10 in the same direction, a reliable connection is effected whether the circuit substrate is a flexible cable or a more rigid circuit board.

In the connectors 10 of the invention, it is possible to actuate the pair of actuators 11 independently from each other. Therefore, after having connected one of the flat cables 51 to the connector 10, it is possible to connect the other flat cable 51 to the connector 10 in a similar manner. This enables an operator to connect the flat cables 51 to the connector 10 in general order with certainty, resulting in the enhancement of easiness, and promptness of connecting operations. Moreover, since it is possible to connect one of the flat cables 51 and the other flat cable to the connector 10 at different times and at different locations, this heightens the flexibility of connecting operations.

Each of the terminals 41 contains the fixed contact beams 43 and the movable beams 44 disposed on one surface side and the other surface side of the flat FPC cables 51 within the cable insertion openings 33, wherein the fixed contact beams 43 and the movable beams 44 have cable supporting portions 43a and the contact portions 44a that face each other.

Each terminal 41 is symmetrical within the pairs of terminals meaning that they are arranged on opposite sides of a straight line situated between the pair of cable insertion openings 33 and which functions as an axis of symmetry. Without having to connect the terminals 41 to a circuit board and the like, it is possible to connect the flat FPC cables 51 together via the terminals 41, and to connect the two flat FPC cables 51 together easily.

Each of the terminals 41 contains the mounting leg portion 47 that also extends along the axis of symmetry and which fixes the terminal 41 to the housing 31. The entire portions of the terminals 41 are located inside the exterior of the housing 31. This enables the connector 10 to be handled easily, and to enhance the workability of connecting operations. The portions 48 of the terminal that joins the pairs of contact beams together may also be provided with through-holes tails or surface mount tails (not shown) so that the connector may be mounted to a circuit board and the circuit substrates also connected to traces on the circuit board, adding to the versatility of the use of the connector.

Since the present invention should not be limited to the above-described embodiment, it is possible to transform the embodiments in various ways based on the gist of the present invention, and these transformations are not eliminated from the scope of the present invention.

1. A relay connector for joining together two free ends of a circuit substrate, the connector comprising:
an insulative housing, the connector housing having a configuration that is symmetrical around a center, longitudinal axis C-C, said connector housing including a pair of slots that receive the free ends of two circuit substrates, the slots being disposed on opposite sides of the longitudinal axis;
a plurality of conductive terminals supported by said connector housing, the terminals being disposed in connected pairs, with each terminal of said pair being disposed in a respective slot, the terminal pairs being disposed on opposite sides of said longitudinal axis, each terminal of said terminal pair including respective first and second contact beams, the first contact beams being fixedly mounted to said connector housing and the second contact beams being moveably mounted to said connector housing; and
a pair of actuators movably mounted to said connector housing on opposite sides of said longitudinal centerline, the actuators being movable between first and second operative positions, wherein in the first operative position, the actuators permit insertion of the circuit substrate ends into said slots and wherein in said second operative position, said actuators force said terminals into contact with said circuit substrates inserted into said slots, said actuators being capable of movement between said first and second operative positions independently from each other.

2. (canceled)

3. The relay connector according to claim 1, wherein each of said first and second contact beams include contact projections extending therefrom toward each other and into said slots.

4. The relay connector according to claim 1, wherein each pair of said first and second contact beams are joined together by an elastic coupling portion intermediate said first and second contact beams, which permits selective movement of said second contact beams toward said first contact beam under urging of said actuator.

5. (canceled)

6. The relay connector of claim 1, wherein said terminals include actuating ends engaged by said actuators, whereby when said actuators are moved to said second operative position, said terminals are forced into contact with said circuit substrate free ends.

7. The relay connector of claim 1, wherein said second contact beams include actuating ends engaged by said actuators, whereby when said actuators are moved to said second operative position, said second contact beams are forced into said slots and into contact with said circuit substrate free ends inserted therein.

8. The relay connector according to claim 6, wherein each of said actuators includes at least one opening disposed therein that receives said terminal actuating ends.

9. The relay connector according to claim 7, wherein said actuators include a plurality of openings disposed therein, each of said opening receiving one of said second contact beam actuating ends.

10. The relay connector according to claim 1, wherein each of the terminals includes a central body portion received in said connector housing along said longitudinal axis, pairs of said first and second contact beams being spaced apart from the central body portion on opposite sides of a longitudinal axis of said central body portion.

11. The relay connector according to claim 10, wherein each of said terminals is symmetrical in configuration and the terminal longitudinal axis defines an axis of symmetry of said terminal.

12. The relay connector according to claim 11, wherein said connector housing is symmetrical about said terminal axes of symmetry.

13. The relay connector according to claim 1, wherein said terminals are supported entirely within said connector housing.

14. The relay connector according to claim 1, wherein said slots open along a common side of said connector housing.

15. The relay connector according to claim 1, wherein said circuit substrate is chosen from the group consisting essentially of: flat flexible circuitry (FFC), flexible printed circuitry (FPC), ribbon cable and printed circuit boards.

16. The relay connector according to claim 1, wherein said circuit substrate is chosen from the group consisting essentially of flat flexible circuitry (FFC) and flexible printed circuitry (FPC).

17. A connector for joining together two free ends of a flexible cable, the connector comprising:
an insulative housing, the connector housing including a central axis running longitudinally between two opposing ends of said connector housing, said connector housing further including pair of slots for receiving free ends of the two cable free ends, the connector housing slots being disposed on opposite sides of the central axis and said slots having openings that face one of said connector housing ends;
a plurality of conductive terminals supported by said connector housing, each of the terminals including a coupling portion for retaining said terminals in place within said connector housing, pairs of first and second contact beams being joined to the coupling portion and extending longitudinally therefrom within said connector housing slots on opposite sides of said central axis, the first contact beams of each of said pairs of first and second contact beams being fixed in said connector housing slots and the second contact beams of each of said pairs of first and second contact beams being movable said connector housing slots with respect to said terminal first contact beams, said terminal second contact beams having actuating ends disposed thereon; and
first and second actuators movably mounted to said connector housing on opposite sides of said central axis, the first and second actuators being movable between first and second operative positions, wherein in the first operative position, said first and second actuators permit insertion of the circuit substrate ends into said connector housing slots and wherein in said second operative position, said first and second actuators engage the terminal second contact beam actuating ends and force said terminal second contact beams of said pairs of first and second contact beams into contact with said free ends of said cables, said first and second actuators being capable of movement between said first and second operative positions independently from each other.

18. The connector of claim 17, wherein for each pair of said first and second contact beams, said first and second contact beams are interconnected by coupling beams intermediate ends of said first and second contact beams.

19. The connector of claim 17, wherein each of said first contact beams includes a bearing portion that abuts against a surface of said housing, and each of said second contact beams includes a contact portion disposed in opposition to said second contact beam bearing portion.

20. The connector of claim 19, wherein said first contact beam bearing portions and said second contact beam contact portions are disposed on opposite sides of said connector housing slots.
